(19) United States
(12) Patent Application Publication
(10) Pub. No.: US 2026/0236925 A1
(43) Pub. Date: Aug. 13, 2026

(54) PAYMENT METHOD AND RELATED DEVICE

(71) Applicant: Tencent Technology (Shenzhen) Company Limited, Shenzhen (CN)

(72) Inventor: Shaoming WANG, Shenzhen (CN)

(73) Assignee: Tencent Technology (Shenzhen) Company Limited, Shenzhen (CN)

(21) Appl. No.: 19/640,407

(22) Filed: Apr. 6, 2026

Related U.S. Application Data
(63) Continuation of application No. PCT/CN2025/080961, filed on Mar. 6, 2025.

(30) Foreign Application Priority Data
Apr. 1, 2024 (CN) 202410396338.7

(51) Int. Cl. G06Q 20/40; G06T 7/90; G06V 10/12

(52) U.S. Cl. CPC G06Q 20/40145; G06T 7/90; G06V 10/12

(57) ABSTRACT

Ambient light information of ambient light in an environment of a biometric verification device is obtained. An ambient light color bias type of the ambient light is determined based on the ambient light information. Based on the ambient light color bias type, ambient light compensation color information for reducing a color bias of the ambient light with the ambient light color bias type is determined. A color compensation image is generated based on the ambient light compensation color information. The color compensation image is displayed by the biometric verification device. When a biometric verification payment instruction is received, a biometric image is acquired under mixed ambient light, the mixed ambient light includes the ambient light and reflected light of the color compensation image that is displayed by the biometric verification device and the mixed ambient light is compensated to have a reduced color bias than the ambient light.

### RELATED APPLICATIONS

The present application is a continuation of International Application No. PCT/CN2025/080961, filed on March 6, 2025, which claims priority to Chinese Patent Application No. 202410396338.7, filed on April 1, 2024. The entire disclosures of the prior applications are hereby incorporated by reference.

### FIELD OF THE TECHNOLOGY

This disclosure relates to the field of computer technologies, including payment technologies, payment methods and related devices.

### BACKGROUND OF THE DISCLOSURE

With the rapid development and increasing maturity of Internet technologies and artificial intelligence technologies, people's lifestyle becomes increasingly convenient and intelligent. Using daily consumption as an example, after selecting a commodity in an offline merchant store, a user can implement payment in manners such as palmprint recognition and face recognition.

In the current related art, when the user intends to purchase a commodity, a biometric image of the user is usually directly acquired. For example, a face image or a palmprint image is acquired, identity verification is performed based on the acquired biometric image, and a payment operation is further performed based on a verification result. However, environmental conditions of the offline merchant store may be complex, and quality of the biometric image acquired in this manner may be relatively poor, to cause identity verification failure and affect payment efficiency.

### SUMMARY

Embodiments of this disclosure provide a payment method and apparatus, a device, a medium, and a program product.

Some aspects of the disclosure provide a method for payment. For example, ambient light information of ambient light in an environment of a biometric verification device is obtained. An ambient light color bias type of the ambient light is determined based on the ambient light information. Based on the ambient light color bias type, ambient light compensation color information for reducing a color bias of the ambient light with the ambient light color bias type is determined. A color compensation image is generated based on the ambient light compensation color information. The color compensation image is displayed by the biometric verification device. When a biometric verification payment instruction is received, a biometric image is acquired under mixed ambient light, the mixed ambient light includes the ambient light and reflected light of the color compensation image that is displayed by the biometric verification device and the mixed ambient light is compensated to have a reduced color bias than the ambient light. When an identity verification based on the biometric image succeeds, a payment operation is performed.

Some aspects of the disclosure provide a biometric verification device. The biometric verification device includes processing circuitry configured to obtain ambient light information of ambient light in an environment of the biometric verification device. The processing circuitry is configured to determine an ambient light color bias type of the ambient light based on the ambient light information. The processing circuitry is configured to determine, based on the ambient light color bias type, ambient light compensation color information for reducing a color bias of the ambient light with the ambient light color bias type The processing circuitry is configured to generate a color compensation image based on the ambient light compensation color information; and display the color compensation image by the biometric verification device. When a biometric verification payment instruction is received, the processing circuitry is configured to acquire a biometric image under mixed ambient light, the mixed ambient light includes the ambient light and reflected light of the color compensation image that is displayed by the biometric verification device, and the mixed ambient light is compensated to have a reduced color bias than the ambient light. The processing circuitry performs a payment operation when an identity verification based on the biometric image succeeds.

Some aspects of the disclosure provide a non-transitory computer-readable storage medium storing instructions which when executed by at least one processor cause the at least one processor to perform the method for payment.

According to an aspect, embodiments of this disclosure provide a payment method, including: obtaining ambient light information of an environment in which a biometric verification device is currently located, and determining an ambient light color bias type of the environment based on the ambient light information; determining, based on the ambient light color bias type, ambient light compensation color information configured for mitigating a color bias of the ambient light color bias type; generating a color compensation image based on the ambient light compensation color information, and displaying the color compensation image; acquiring, in response to a biometric verification payment instruction, a biometric image under mixed ambient light that is compensated by reflected light of the color compensation image in the environment in which the biometric verification device is located; and performing a payment operation when identity verification based on the biometric image succeeds.

According to another aspect, embodiments of this disclosure provide a payment apparatus. The apparatus includes: an obtaining unit, configured to obtain ambient light information of an environment in which a biometric verification device is currently located, and determine an ambient light color bias type of the environment based on the ambient light information; a determination unit, configured to determine, based on the ambient light color bias type, ambient light compensation color information configured for mitigating a color bias of the ambient light color bias type; a generation unit, configured to generate a color compensation image based on the ambient light compensation color information, and display the color compensation image; an acquisition unit, configured to acquire, in response to a biometric verification payment instruction, a biometric image under mixed ambient light that is compensated by reflected light of the color compensation image in the environment in which the biometric verification device is located; and an execution unit, configured to perform a payment operation when identity verification based on the biometric image succeeds.

Embodiments of this disclosure provide a biometric verification device, including a processor (an example of processing circuitry) and a memory, a plurality of instructions being stored in the memory, and the instructions being loaded by the processor, to perform the operations in the payment method provided in the embodiments of this disclosure.

Embodiments of this disclosure further provide a computer-readable storage medium (e.g., non-transitory computer-readable storage medium), having a computer program stored therein. The computer program, when executed by a processor, implements the operations in the payment method provided in the embodiments of this disclosure.

In addition, embodiments of this disclosure further provide a computer program product, including a computer program or instructions, the computer program or the instructions, when executed by a processor, implementing the operations in the payment method provided in the embodiments of this disclosure.

Details of one or more embodiments of this disclosure are provided in the accompanying drawings and descriptions below. Other features, objectives, and advantages of this disclosure become apparent from the specification, the drawings, and the claims.

### BRIEF DESCRIPTION OF THE DRAWINGS

FIG. 1 is a schematic diagram of a scenario of a payment method according to an embodiment of this disclosure.

FIG. 2 is a flowchart of a payment method according to an embodiment of this disclosure.

FIG. 3 is an illustration diagram of a payment method according to an embodiment of this disclosure.

FIG. 4 is another flowchart of a payment method according to an embodiment of this disclosure.

FIG. 5 is another illustration diagram of a payment method according to an embodiment of this disclosure.

FIG. 6 is another illustration diagram of a payment method according to an embodiment of this disclosure.

FIG. 7 is another illustration diagram of a payment method according to an embodiment of this disclosure.

FIG. 8 is another flowchart of a payment method according to an embodiment of this disclosure.

FIG. 9 is a schematic structural diagram of a payment apparatus according to an embodiment of this disclosure.

FIG. 10 is a schematic structural diagram of a biometric verification device according to an embodiment of this disclosure.

### DETAILED DESCRIPTION

The following describes technical solutions in embodiments of this disclosure with reference to the accompanying drawings. The described embodiments are some of the embodiments of this disclosure rather than all of the embodiments. Other embodiments are within the scope of this disclosure.

Descriptions of terms in this disclosure are provided as examples only and are not intended to limit the scope of the disclosure.

The payment method in this embodiment may be performed on a biometric verification device, or may be performed by both the biometric verification device and a server. The foregoing examples are not be construed as a limitation to this disclosure.

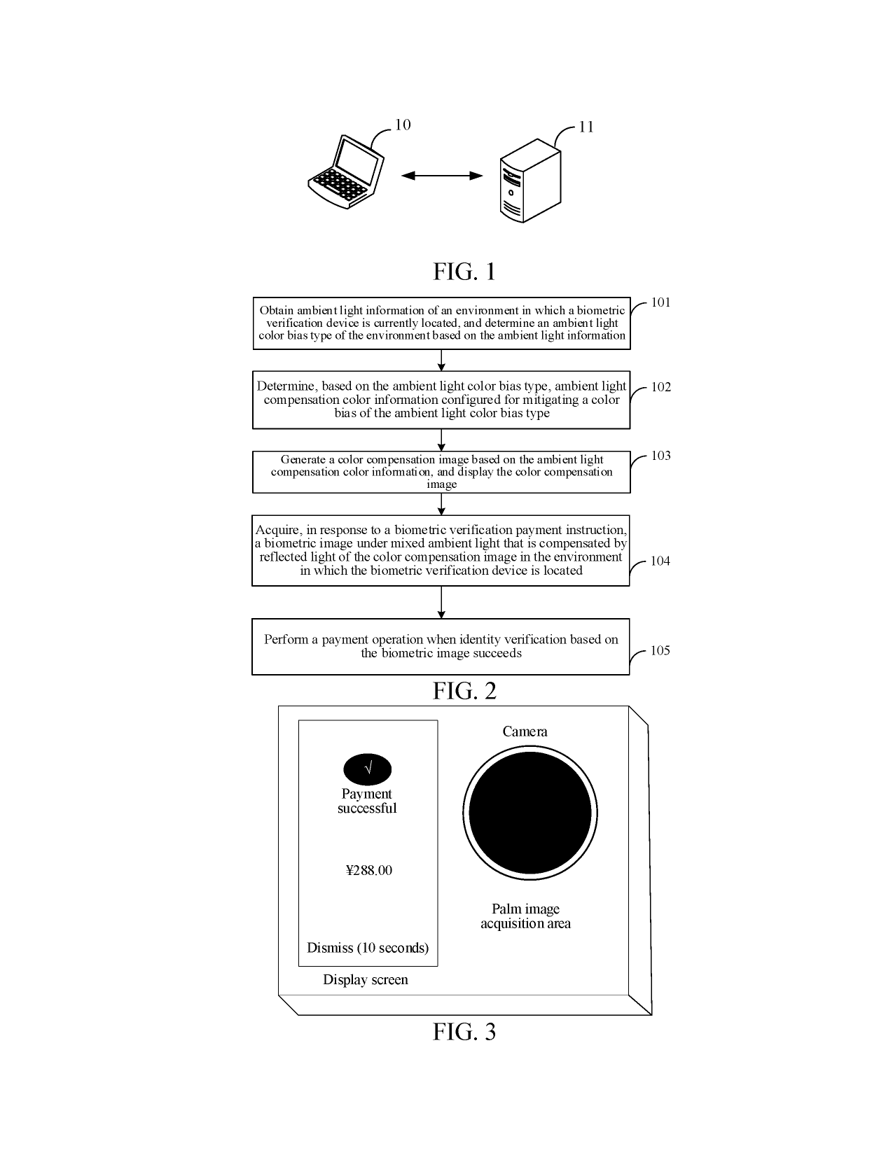

As shown in FIG. 1, an example in which a biometric verification device and a server jointly perform a payment method is used. A payment system provided in embodiments of this disclosure includes a biometric verification device 10, a server 11, and the like. The biometric verification device 10 is connected to the server 11 over a network, for example, over a wired or wireless network. A payment apparatus may be integrated in the biometric verification device.

The biometric verification device 10 may be configured to: obtain ambient light information of an environment in which the biometric verification device is currently located; determine an ambient light color bias type of the environment based on the ambient light information; determine, based on the ambient light color bias type, ambient light compensation color information configured for mitigating a color bias of the ambient light color bias type; generate a color compensation image based on the ambient light compensation color information, and display the color compensation image; acquire, in response to a biometric verification payment instruction, a biometric image under mixed ambient light that is compensated by reflected light of the color compensation image in the environment in which the biometric verification device is located; and perform a payment operation when identity verification based on the biometric image succeeds. The biometric verification device 10 may include a mobile phone, an in-vehicle device, an aircraft device, a tablet computer, a laptop, a personal computer (PC), or the like. A client side may further be provided on the biometric verification device 10, and the client side may be an application client side, a browser client side, or the like.

The server 11 may be configured to: receive the ambient light information transmitted by the biometric verification device 10, to determine an ambient light color bias type corresponding to the ambient light information; determine, based on the ambient light color bias type, ambient light compensation color information configured for mitigating a color bias of the ambient light color bias type; and generate a color compensation image based on the ambient light compensation color information, and transmit the color compensation image to the biometric verification device 10 for display. The server 11 may further receive the biometric image acquired by the biometric verification device 10, to perform identity verification on the biometric image, and return a verification result to the biometric verification device 10. The server 11 may be an independent physical server, or may be a server cluster composed of a plurality of physical servers or a distributed system, and may further be a cloud server providing a cloud computing service.

The foregoing operations such as generating the color compensation image performed in the server 11 may alternatively be performed by the biometric verification device 10.

The payment method provided in the embodiments of this disclosure relates to a computer vision technology in the field of artificial intelligence.

Artificial intelligence (AI) is a theory, method, technology, and application system that uses a digital computer or a machine controlled by the digital computer to simulate, extend, and expand human intelligence, perceive an environment, obtain knowledge, and use knowledge to obtain an optimal result. In other words, AI is a comprehensive technology in computer science and attempts to understand the essence of intelligence and produce a new intelligent machine that can react in a manner similar to human intelligence. AI is to study design principles and implementation methods of various intelligent machines, to enable the machines to have functions of perception, reasoning, and decision-making. The AI technology is a comprehensive discipline, and relates to a wide range of fields including both hardware-level technologies and software-level technologies. AI software technologies include major directions such as a computer vision technology, a speech processing technology, a natural language processing technology, machine learning/deep learning, autonomous driving, and intelligent traffic.

A computer vision (CV) technology is a science that studies how to enable a machine to "see". In some examples, the CV technology uses cameras and computers to replace human vision for object recognition and measurement, and further performs graphic processing, so that the computer processes the target into an image more suitable for human eyes to observe, or an image transmitted to an instrument for detection. As a scientific discipline, CV studies related theories and technologies and attempts to establish an AI system that can obtain information from images or multidimensional data. The computer vision technology may include technologies such as image processing, image recognition, image semantic understanding, image retrieval, optical character recognition (OCR), video processing, video semantic understanding, video content/behavior recognition, three-dimensional object reconstruction, a three-dimensional (3D) technology, virtual reality, augmented reality, synchronous positioning and map construction, autonomous driving, and smart transportation, and may further include biometric recognition technologies such as common face recognition, palmprint recognition, and fingerprint recognition.

Further descriptions are separately provided below. A description order of the following embodiments is not used as a limitation on a priority order of the embodiments.

This embodiment is described from the perspective of a payment apparatus. The payment apparatus may be integrated into a biometric verification device.

As shown in FIG. 2, a procedure of the payment method may be as follows:

101: Obtain ambient light information of an environment in which a biometric verification device is currently located, and determine an ambient light color bias type of the environment based on the ambient light information.

The biometric verification device may be a user identity recognition device such as a palm verification device or a face verification device. These devices implement user identity verification based on a biometric recognition technology and by using technologies such as computer vision and pattern recognition. Generally, the biometric verification device may be placed in an offline merchant store, and the environment in which the biometric verification device is currently located may be the offline merchant store in which the biometric verification device is placed.

The ambient light information is information about features and properties of light in an ambient environment, and may include brightness, a color temperature, a hue, and the like of ambient light. By analyzing the ambient light information, a color bias state of a current environment may be obtained. In some examples, the ambient light information of the current environment may be obtained by using various sensors, such as a photometer, a camera, and an optical sensor. These sensors can measure parameters such as an intensity and a color of light and convert the parameters into a usable digital signal. In some embodiments, the ambient light information of the current environment may be obtained by acquiring an environment image.

The ambient light color bias type refers to a color bias exhibited by the ambient light, and may include color biases such as a blue bias, a red bias, and a green bias. The blue bias refers to a condition in which a blue chromatic component is relatively high. In a red, green, blue (RGB) color mode, a blue component value of the blue bias is relatively high. In a CIELAB color space, the blue bias is reflected in a shift of the a value towards a negative direction and a relatively stable b value, presenting a blue-dominated color tendency. The red bias refers to a condition in which a red component value is relatively high in the RGB color mode. In the CIELAB color space, the red bias is reflected in a significant shift of the a value towards a positive direction and a relatively small change of b value, presenting a red-dominated color characteristic. The green bias refers to a condition in which a green component value is dominant in the RGB color mode. In the CIELAB color space, the green bias is reflected in a shift of the a value towards the negative direction (less pronounced than in the blue bias) and a variation of the b value towards the positive direction, presenting a green-dominated color tendency.

In some examples, a feature of the ambient light can affect accuracy of tasks such as identity detection and identification. In this disclosure, the ambient light color bias type corresponding to the ambient light information can be analyzed, and the color compensation image is generated based on the ambient light color bias type, so that the biometric image is acquired with reference to diffuse reflection of the color compensation image, to obtain better image quality.

In an embodiment, the operation of "obtaining ambient light information of an environment in which a biometric verification device is currently located, and determining an ambient light color bias type of the environment based on the ambient light information" may include: acquiring an environment image of the environment in which the biometric verification device is currently located; and performing a color analysis on the environment image, to determine the ambient light color bias type of the environment image.

The environment image may be an image acquired by using a front-facing camera of the biometric verification device. In some examples, the biometric verification device integrates a display screen and camera hardware, and the camera hardware is located on a same side of the display screen of the biometric verification device.

The acquired environment image may include ambient light information. In some examples, the environment image may be an image in the RGB color mode.

In an embodiment, the operation of "performing a color analysis on the environment image, to determine the ambient light color bias type of the environment image" may include: performing color space conversion on the environment image, to obtain a converted image; performing area division on the converted image, to obtain a plurality of image areas; and determining the ambient light color bias type of the environment image based on color bias information of each image area.

The performing color space conversion on the environment image may be converting the environment image from an RGB color space to another color space, such as YCbCr or Lab. The YCbCr or Lab color space may separate information such as brightness and chroma, thereby better representing a color feature of the image. The converted image may be an image in the YCbCr or Lab color space.

YCbCr is a type of color space, where Y refers to a brightness component, Cb refers to a blue chroma component, and Cr refers to a red chroma component. A Lab color model includes three elements, namely, luminosity (L) and a and b that are color-related. L denotes luminosity, equivalent to brightness, a denotes a range from red to green, and b denotes a range from blue to yellow.

Area division is performed on the converted image, to analyze color bias information of each area. There are multiple manners of performing area division on the converted image. For example, the area division manner of the converted image may be dividing the converted image into N image areas based on a preset quantity N, where the N image areas may be the same in size or may be different in size. For another example, the area division manner may be dividing the converted image into a plurality of image areas of a preset area size.

In an embodiment, the operation of "determining the ambient light color bias type of the environment image based on color bias information of each image area" may include: calculating, for each image area, area color temperature information of the image area; determining the color bias type of the image area based on the area color temperature information of the image area; and collecting statistics on a color bias type of each image area, to obtain frequency information of occurrence of each preset color bias type; and determining the ambient light color bias type of the environment image based on the frequency information.

The ambient light color bias type of an entire environment image may be determined based on the color bias information of each image area.

The preset color bias type may include a blue bias, a red bias, a green bias, and the like.

In some examples, a higher color temperature indicates a stronger blue bias of the light; and a lower color temperature indicates a strong red bias of the light. The area color temperature information of the image area may reflect a color bias state of the ambient light. In this embodiment, the area color temperature information of the image area may be an average color temperature of the image area. Statistics collection is performed on the color bias type of each image area to determine a color bias type having a highest frequency of occurrence, and the color bias type having a highest frequency of occurrence is taken as the ambient light color bias type of the environment image.

In an embodiment, the converted image may be divided into several small areas. For example, the converted image may be divided into 8×8 or 16×16 blocks, each block is an image area, and then an average color temperature or a color deviation of each image area is calculated. In this manner, a local color change in an image can be better accommodated. Statistics collection and analysis are then performed on the average color temperature or the color deviation of each image area, to find out the most common color bias type (for example, entire blue bias, red bias, and green bias) in the image, and finally obtain the color bias state of the current image.

102: Determine, based on the ambient light color bias type, ambient light compensation color information configured for mitigating a color bias of the ambient light color bias type.

Ambient light compensation color information: Ambient light compensation color information may refer to related color information that is determined based on an ambient light color bias type by using a color superposition algorithm and the like and is used for mitigating a color bias of the ambient light color bias type. For example, when the ambient light exhibits a blue bias, the ambient light compensation color information may be red, and the color bias of the ambient light is neutralized by adding a color compensation image of a corresponding color to produce diffusely reflected light.

Color superposition algorithm: Based on an additive color principle of an RGB color space, in an RGB color mode, when three colors, namely, red, green, and blue are mixed in equal proportions, color components of the three colors balance each other, and a white color is rendered after the mixing. However, a superposition effect of different colors depends on the combination of components in the RGB color space. Compensation color information corresponding to ambient light color bias type is calculated by using the algorithm, to neutralize the color bias of the ambient light.

In some examples, the biometric verification device may determine, based on the ambient light color bias type, the ambient light compensation color information configured for mitigating the color bias of the ambient light color bias type by using the color superposition algorithm. Mitigating the color bias of the ambient light color bias type may refer to adjusting the color bias of the ambient light color bias type.

In this embodiment, the operation of "determining, based on the ambient light color bias type, ambient light compensation color information configured for mitigating a color bias of the ambient light color bias type" may include: obtaining a color compensation mapping relation set based on the color superposition algorithm, the color compensation mapping relation set including a mapping relation between each preset color bias type and ambient light compensation color information; and determining, based on the color compensation mapping relation set, ambient light compensation color information configured for adjusting the ambient light color bias type.

The color superposition algorithm is based on the additive color principle of the RGB color space. In the RGB color mode, when three colors: red, green, and blue are mixed in equal proportions, color components of the three colors balance each other, and the white color is rendered after the mixing. However, not any superposition of colors can produce white, and a superposition effect of different colors depends on the combination of components in the RGB color space.

The color compensation mapping relation set may be a table of a relation between the preset color bias type and ambient light compensation color information. Based on the ambient light color bias type, corresponding ambient light compensation color information is looked up from the table of the relation.

Preset color bias type: A preset color bias type may refer to a preset color bias type that may be exhibited by the ambient light, including a blue bias, a red bias, a green bias, and the like. Statistics collection is performed on the color bias type of each image area, to determine the preset color bias type having a highest frequency of occurrence, and the preset color bias type having a highest frequency of occurrence is taken as the ambient light color bias type of the environment image.

In some examples, when the preset color bias type is the blue bias, the ambient light compensation color information may be red, and the diffusely reflected light is produced by adding a red color compensation image to neutralize blue ambient light. When the ambient light exhibits a blue color bias, a red color compensation image is generated, and diffusely reflected light of the compensation image can neutralize the blue ambient light. When the preset color bias type is a yellow bias, the ambient light compensation color information may be blue, and the diffusely reflected light is produced by adding a blue color compensation image to neutralize yellow ambient light. When the ambient light exhibits a yellow color bias, a blue color compensation image is generated, and diffusely reflected light of the blue color compensation image can neutralize the yellow ambient light.

The ambient light compensation color information herein does not need to specify a clear color value, and essentially, it is sufficient to generate a color compensation image within a corresponding color range. In this embodiment, the diffuse reflection of the color compensation image is used to adjust the color bias of the ambient light. This can help improve the quality of the acquired biometric image.

103: Generate a color compensation image based on the ambient light compensation color information, and display the color compensation image.

In some embodiments, the color compensation image may be a solid color image, and the color of the color compensation image is determined based on the ambient light compensation color information. In some other embodiments, the ambient light compensation color information may be used as a background color of the color compensation image, and another image element may be added.

In this embodiment, the operation of "generating a color compensation image based on the ambient light compensation color information, and displaying the color compensation image" may include: performing item recognition on the environment image to obtain an item type currently promoted by the environment in which the biometric verification device is located; and generating the color compensation image based on the ambient light compensation color information and the item type, and displaying the color compensation image.

In some examples, the environment in which the biometric verification device is located may be an offline merchant store, the environment image may include some commodities sold in the offline merchant store, and an item type currently promoted to be sold in the offline merchant store may be determined by performing item recognition on the environment image, so as to generate the color compensation image based on the ambient light compensation color information and the item type. For example, the ambient light compensation color information may be used as a background color of an image, and then an image element related to the item type is added, to generate the color compensation image. The generated color compensation image may be used as a poster of the offline merchant store, to promote commodities of these item types by using the poster.

Item type: An item type may refer to a commodity type currently promoted in an environment in which the biometric verification device is located, is determined by performing item recognition processing on an environment image by using an artificial intelligence (AI) image recognition technology through feature extraction of an image recognition model, classification of a support vector machine, and the like, and may be used for generating a color compensation image, for example, may be used as a poster-promoted commodity in an offline merchant store by adding a related image element.

In some embodiments, the generating the color compensation image based on the ambient light compensation color information and the item type, and displaying the color compensation image may include: inputting the ambient light compensation color information and the item type to an artificial intelligence image generation model; and generating the color compensation image based on the ambient light compensation color information and the item type by using the artificial intelligence image generation model.

Item recognition may be performed on the environment image by using an AI image recognition technology. In some examples, feature extraction may be performed on the environment image by using an image recognition model, to obtain image feature information, and then the item type in the environment image is predicted based on the image feature information by using a classification algorithm such as a support vector machine (SVM).

Image recognition model: It may be, for example, a convolutional neural network, configured to perform feature extraction on an image, to obtain image feature information, to perform an operation related to image recognition, for example, perform recognition and classification on an item in the environment image. The image recognition model may be the convolutional neural network or the like. This is not limited in this embodiment. Convolutional neural network (CNN): An image recognition model may be configured to perform an operation such as feature extraction on an image, for example, in an AI image recognition technology, perform feature extraction on an environment image, to recognize an item in the image.

The biometric verification device or the server may convert the ambient light compensation color information into corresponding color parameter data, and convert the item type into corresponding feature identifier data, and input the feature identifier data into an artificial intelligence image generation model such as the CNN. First, the model performs feature extraction on inputted data, and fuses a feature of the ambient light compensation color information with a feature of the item type. Then, the model generates a corresponding image element based on the fused feature. For example, a corresponding commodity image element is generated based on the item type, and a background color of the image is determined based on the ambient light compensation color information. Finally, the generated image elements are laid out and composited, to obtain the color compensation image.

In this embodiment, the operation of "generating a color compensation image based on the ambient light compensation color information, and displaying the color compensation image" may include: generating an initial compensation image based on the ambient light compensation color information and the item type; obtaining a marketing requirement selection instruction; and determining, when the marketing requirement selection instruction instructs not to perform marketing, the initial compensation image as a to-be-presented color compensation image, and displaying the color compensation image.

In this embodiment, after the initial compensation image is generated based on the ambient light compensation color information and the item type, a user may be asked whether marketing information should be inputted to further regenerate a poster, and a marketing requirement selection instruction inputted by the user is obtained. If the user chooses not to perform the marketing, the initial compensation image may be directly used as a finally displayed color compensation image. If the user chooses to perform the marketing, image generation is to be performed again.

Marketing requirement selection instruction: A marketing requirement selection instruction may refer to an instruction inputted by a user and used for instructing whether to perform the marketing. After generating the initial compensation image based on the ambient light compensation color information and the item type, the biometric verification device requests the user to input the instruction; if the instruction instructs not to perform the marketing, directly displays the initial compensation image; and if the instruction instructs to perform the marketing, obtains marketing information to regenerate target promotion content.

In this embodiment, the payment method may further include: obtaining marketing information when the marketing requirement selection instruction instructs to perform the marketing; and generating and displaying target promotion content based on the ambient light compensation color information, the item type, and the marketing information.

When the user chooses to perform the marketing, marketing information configured by the user may be obtained. The marketing information may be marketing information for a commodity, and may include a marketing title of the commodity, a commodity image, an activity date, a discount amount, and the like. After the marketing information is obtained, the ambient light compensation color information may be used as the background color of the image, and the marketing information and the item type corresponding to the environment image are fused, to generate the target promotion content. Target promotion content: promotion content that is generated based on the ambient light compensation color information, the item type, and the marketing information when a user selects to perform marketing, for example, content that is generated by using the ambient light compensation color information as the background color of the image and by fusing marketing information and the item type corresponding to the environment image.

In this embodiment, the operation of "generating a color compensation image based on the ambient light compensation color information, and displaying the color compensation image" may include: determining, based on the ambient light compensation color information and the item type, promotion image style information for an environment in which the biometric verification device is located; obtaining an original promotion image; fusing the promotion image style information with the original promotion image, to obtain the color compensation image; and displaying the color compensation image.

The original promotion image may be a poster originally uniformly designed by an official entity or a merchant. The promotion image style information may refer to an electronic poster style template suitable for an environment in which the biometric verification device is located, and may include the ambient light compensation color information and the item type of the environment in which the biometric verification device is located.

In a scenario example, an electronic poster of a user identity recognition device may be uniformly designed by an official entity or a merchant. However, environments of individual offline merchant stores are complex, commodities are diversified, and costs of store-by-store investigation and adaptation on a merchant side are excessively high. The biometric verification device of this disclosure can automatically learn knowledge of an environment, to generate an electronic poster (a color compensation image) more attractive to a user. In some examples, the ambient light information and the type of the commodity sold in the store are determined by acquiring the environment image, and then the ambient light compensation color information configured for adjusting the ambient light information is determined, so as to generate the color compensation image based on the ambient light compensation color information and the type of the commodity. The generated color compensation image may be more user-attractive. In addition, in a user payment process, the ambient light may be adjusted through diffuse reflection of the color compensation image. This is beneficial to improving the quality of the acquired biometric image.

There are multiple manners of fusing the promotion image style information and the original promotion image. This is not limited in this embodiment. For example, the fusion manner may be adding the promotion image style information to the original promotion image, to obtain the color compensation image.

104: Acquire, in response to a biometric verification payment instruction, the biometric image under mixed ambient light that is compensated by reflected light of the color compensation image in the environment in which the biometric verification device is located.

The biometric verification device may acquire, in response to the biometric verification payment instruction of the user for resources to be traded, the biometric image of the user under mixed ambient light that is compensated by reflected light of the color compensation image in the environment in which the biometric verification device is located.

Biometric image: When the biometric verification device is a face verification device, the biometric image may be a face image; and when the biometric verification device is a palm verification device, the biometric image may be a palmprint image. The biometric image is an image configured for identity verification.

Mixed ambient light: Mixed ambient light may refer to light that is formed by mixing the original ambient light and reflected light of the color compensation image in the environment in which the biometric verification device is located. The mixed light can reduce a color bias of the original ambient light, and facilitate acquisition of a biometric image with higher quality.

In this embodiment, the reflected light generated by the color compensation image may be used to neutralize the color bias of the ambient light, so that the color bias of the acquired biometric image is reduced, facilitating improving quality of the biometric image.

The user may be a user performing a transaction, and may be a user purchasing a commodity. Biometric verification payment instruction: A biometric verification payment instruction may be an instruction that is issued by a user for resources to be traded (for example, an item to be purchased) and that requests biometric verification to complete a payment. Resources to be traded: Resources to be traded may refer to an item that a user intends to purchase, and the user issues the biometric verification payment instruction for the resources to be traded, to complete a purchase payment for the item.

In some examples, when the biometric verification device is the face verification device, the biometric image may be the face image. When the biometric verification device is the palm verification device, the biometric image may be the palmprint image.

105: Perform a payment operation when identity verification based on the biometric image succeeds.

After the biometric image is acquired, identity verification is to be performed on the biometric image. After verification succeeds, the payment operation may be performed, to initiate a payment process. Payment process: A payment process may refer to a series of operation processes of performing payment after identity verification of the biometric image succeeds, including operations such as deducting a corresponding amount from a user account and transferring the deducted amount to a payee.

In some examples, before configuring a poster (that is, a color compensation image) based on environment information, the biometric verification device needs to be initialized and configured with a poster updating capability, as described below:

After deploying the biometric verification device at a merchant store, a merchant powers on the biometric verification device. Upon startup, the biometric verification device enters an initialization stage. During the initialization stage, the biometric verification device may be bound to the payee based on identity information of the payee (such as palmprint information and face information). After the binding is successfully completed, the poster updating capability of the biometric verification device may be configured.

In a scenario example, the biometric verification device may be a palm verification device (e.g., the palm verification device) and can be used in offline merchant stores. As shown in FIG. 3, the biometric verification device may be integrated with a camera and a display screen. The camera corresponds to a palm image acquisition area and may be configured to acquire a palmprint image. When a customer purchases a commodity, the customer can perform a palmprint scan in the palm image acquisition area of the biometric verification device. The biometric verification device acquires a palmprint image of the customer through the camera and performs identity verification based on the acquired palmprint image. Upon successful verification, a corresponding payment process is performed. After the payment is completed, a payment result, such as a payment amount and confirmation of successful payment, can be displayed on the display screen of the biometric verification device. Palm image acquisition area: A palm image acquisition area may refer to an area corresponding to a camera on a palm verification device, and a user performs a palmprint scan in the area, so that the palm verification device acquires a palmprint image.

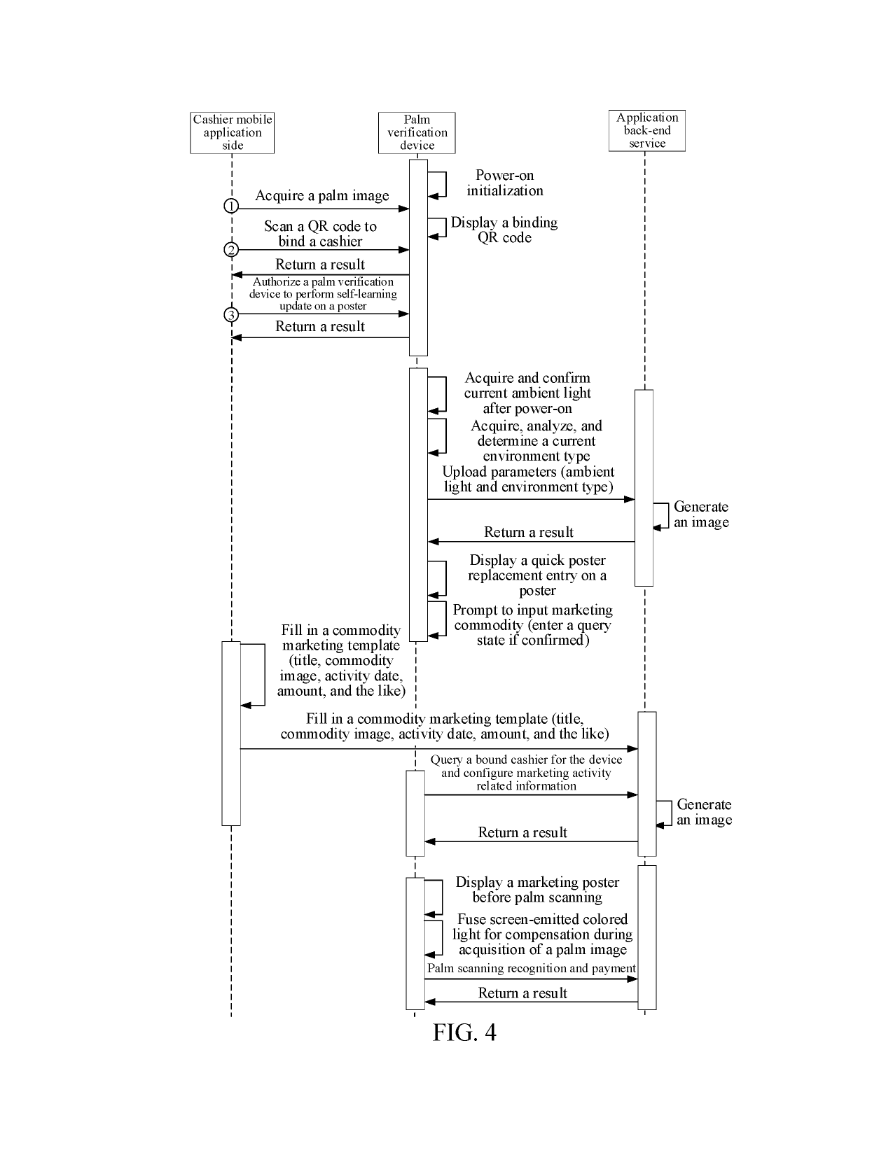

In some examples, initialization of the palm verification device, configuration of the poster update capability, and a palm verification payment process may be shown in FIG. 4, and are described as follows:

First, after the palm verification device is deployed at the merchant store, a cashier powers on the palm verification device. After being powered on, the palm verification device enters an initialization stage and subsequently requests the cashier to further acquire a palm image for binding. After the cashier scans a palm, the palm verification device displays quick response (QR) code information uniquely bound to the device. The QR code information is a character string serial number (SN) of the palm verification device. The SN is identification (ID) capable of uniquely identifying a device. The cashier then uses an instant messaging application (App) that has already been logged in, to scan the QR code so as to bind a relation between a currently logged-in cashier application account and the device. After the binding is successful, the cashier needs to authorize, via a mini-program on a mobile application side, the palm verification device to perform self-learning update on a poster (this capability may be disabled by default). At this point, the initialization of the palm verification device and the configuration of the poster update capability are completed. After a self-learning poster update capability is successfully enabled, the palm verification device may feed back a successful activation result to a cashier mobile application side. Mini-program: A mini-program may be a lightweight application program running on a platform such as an instant messaging application. A cashier may perform, on the mini-program on the mobile application side, operations such as authorizing a palm verification device to update a poster and input marketing information.

After the cashier configures the palm verification device to enable the self-learning poster update capability, the palm verification device, upon being powered on, acquires current ambient light and a current environment type. Essentially, when the palm verification device is idle, it captures several images of the current environment and uploads the captured environment images to an application back-end service for analysis and recognition, so as to obtain lighting conditions of a store in which the device is located and information regarding the types of commodities being sold.

The application back-end service: The application back-end service may be configured to receive data uploaded by the biometric verification device, including ambient light information, environment images, and the like, to perform analysis and processing on the data, such as determining an ambient light type, recognizing commodity types, and generating electronic posters, and to return processing results to the biometric verification device. The ambient light information is acquired and transmitted to the application back-end service for analysis primarily to determine a current ambient light type. Different ambient light color bias scenarios may reduce the accuracy and pass rate of the palm verification algorithm. Therefore, color compensation may be beneficial. In some examples, adjustment of palm imaging is achieved based on the fact that the display screen of the palm verification device emits light. Posters of different colors generate different colored light, and the light produces diffuse reflection and further affects the final imaging of a palm of the user. By analyzing the color bias state of the current ambient light with reference to the ambient light and referring to colored light generated by the electronic poster, color adjustment of the palm image can be achieved.

A type of a commodity currently sold in a store may be analyzed by using a store image. In some examples, the store image acquired by the palm image acquisition camera needs to be preprocessed, and then a commodity in the store image is recognized by using an AI image recognition technology. For example, feature extraction may be performed on the store image by using a convolutional neural network, and the commodity is classified by using a classification algorithm such as a support vector machine (SVM). Then the recognized commodity is classified. A commodity classification database may be configured to classify commodities, or a deep learning-based method may be configured for classifying the commodities. Types of the commodities sold in the store are analyzed based on the recognized commodities and the category of the commodities; and, a statistical method may be configured for classifying and collecting statistics on a commodity, to obtain a type of a commodity sold in a store.

Commodity classification database: A commodity classification database may be a database configured to classify commodities, and classification and statistics collection may be performed on a recognized commodity based on a classification rule in the database, to obtain a type of a commodity sold in a store.

After receiving the type of the ambient light and the commodity classification type of a current store, the back-end service generates a corresponding electronic poster and returns the corresponding electronic poster to the palm verification device. Subsequently, a default poster interface displays a quick poster replacement entry. Upon clicking this entry, the user is asked whether to input marketing commodities to further regenerate a poster. If the user chooses not to input the marketing commodities, the current electronic poster that is generated based on the ambient light and store classification may be applied.

If the cashier chooses to input the marketing commodities, the cashier is required to open a commodity entry template within the palm verification mini-program on the mobile application side and fill in commodity information such as a marketing title of a commodity, a commodity image, an activity date, a discount amount, and the like. After the cashier enters the information, the information is transmitted to the application back-end service. Meanwhile, the device continuously queries marketing activity information configured by the cashier for the currently bound device. If such information is obtained, the previously acquired ambient light, the commodity type, and the current marketing commodity information are all transmitted to the application back-end service and analyzed using an AI generative content (AIGC) engine, a corresponding poster is generated, and a final result is then returned to the palm verification device. The AIGC is artificial intelligence generative content.

Subsequently, upon arriving at the store, the user can quickly obtain information such as current marketing activities and related commodities through the current electronic poster. After confirming the commodity information, the user may perform palm verification payment. During palm image acquisition, the device performs a fusion capture by integrating the current ambient light with light reflected from the electronic poster. The captured palm image is then transmitted to the application back-end service for palmprint recognition. In some examples, the palm verification payment process may be as follows: a three-dimensional (3D) camera is activated to acquire real-time palm streaming data of the user, and upon obtaining the streaming data, the biometric verification device performs optimal frame selection on the stream. The optimal frame selection refers to comprehensively evaluating and selecting an optimal palm image based on factors such as palm size, angle, image contrast, image brightness, and image clarity. Subsequently, the optimal palm image is transmitted to the application back-end service to perform palm recognition, and further obtain information related to a user payment code corresponding to the palm.

Three-dimensional (3D) camera: analogous to a conventional camera, the 3D camera incorporates liveness-related hardware and software, including a depth camera and an infrared camera, to ensure information security. Palm recognition refers to a technology for obtaining identity information of a user based on multimedia information of a palm. Palm streaming data: Palm streaming data is dynamic data of a palm of a user that is acquired by the 3D camera. The biometric verification device may perform optimal frame selection on the data to select an optimal palm image for identity recognition.

This disclosure may provide a dynamic electronic poster generation solution based on environment self-learning. In some examples, the solution may generate an electronic poster most suitable for a current store device by combining ambient light, commodity types, and cashier-configured marketing strategies of the store. The solution not only supports an improved service experience but also meets merchant-side marketing requirements. Moreover, during a user payment process, the diffuse reflection produced by the electronic poster generated by this method can be utilized to adjust a color bias in the ambient light, thereby facilitating the acquisition of higher-quality biometric images.

In some examples, according to this disclosure, after deployment of the biometric verification device (such as the palm verification device or the face verification device) at a merchant store, the biometric verification device performs recognition and classification on commodities and light in the environment by using the camera, to obtain an electronic poster style template (suitable for marketing and fusing ambient light to generate an electronic poster style more conducive to palm illumination for recognition) that is most suitable for merchant store display; and by combining cashier-configured, periodic marketing requirements for store commodities, captured images, and the like, the AIGC engine is employed to generate final electronic poster content that is most suitable for the store.

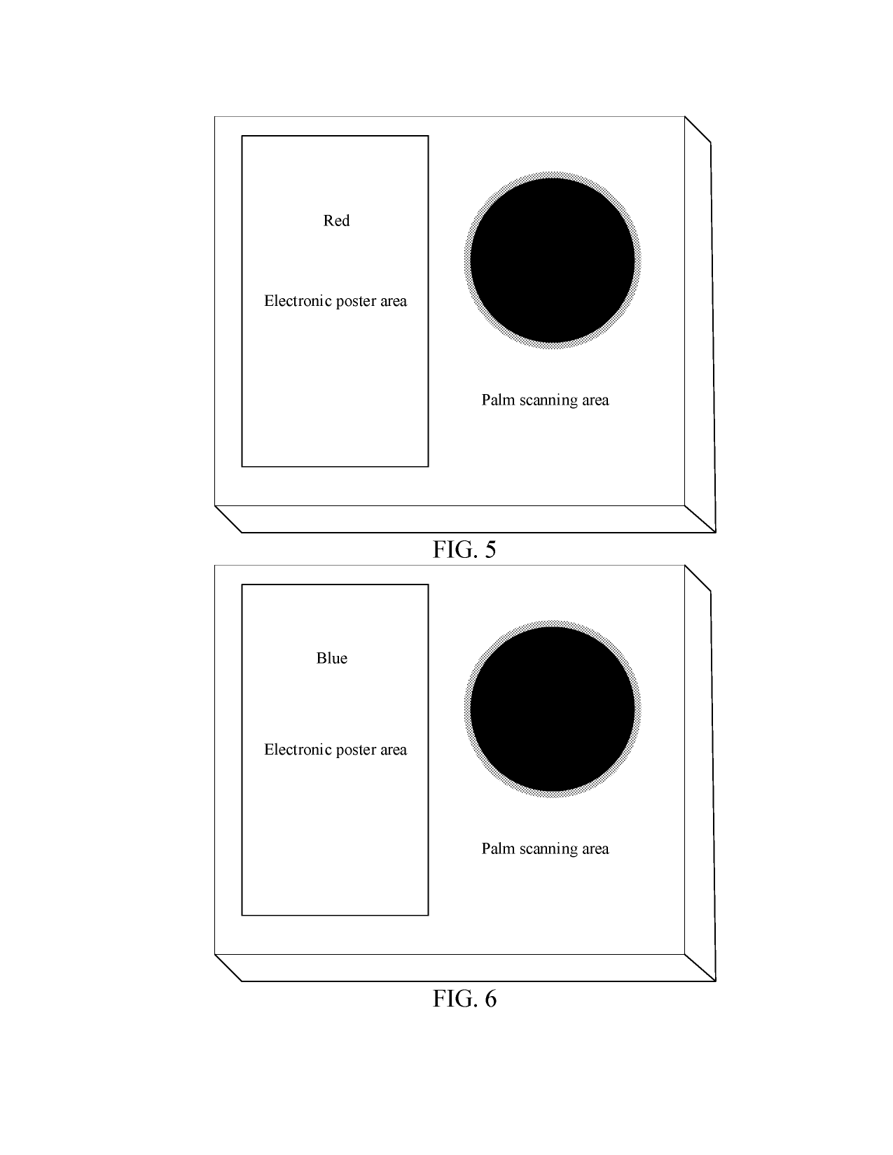

For example, when a color bias type corresponding to the ambient light is detected to be a blue bias, the corresponding ambient light compensation color information can be determined as red based on a color compensation mapping relation set. In this manner, a red electronic poster may be generated and displayed, as shown in FIG. 5. When the ambient light with a blue bias is detected, a red electronic poster is generated and displayed, and diffuse reflected light of the red electronic poster can neutralize the blue ambient light, to improve the acquisition quality of a palmprint image. When a user performs palm verification payment in front of the palm image acquisition area, the diffuse reflection generated by the red electronic poster may be used to adjust the ambient light with the blue bias and acquire the palmprint image. In this manner, color bias in the acquired palmprint image can be effectively reduced.

For example, when the color bias type corresponding to the ambient light is detected to be a yellow bias, corresponding ambient light compensation color information can be determined as blue based on the color compensation mapping relation set. In this manner, a blue electronic poster may be generated and displayed, as shown in FIG. 6. When a user performs palm verification payment in front of the palm image acquisition area, diffuse reflection generated by the blue electronic poster may be used to adjust the ambient light with the yellow bias and acquire the palmprint image. In this manner, color bias in the acquired palmprint image can be effectively reduced.

A procedure of generating a poster by using the AIGC may be as follows:

The commodity type and the ambient light color bias type are inputted into an AI model. The AI model may be an image generation model, and may be a convolutional neural network and the like. The AI model uses the commodity type as a keyword to generate corresponding commodity elements, and generates a corresponding background layer based on the ambient light color bias type. The commodity elements are then superposed onto the background layer, the size and position of the commodity elements are controlled, and fine tuning and layout are performed to complete generation of the poster.

Image generation model: The image generation model is one type of AI model, and can generate corresponding image content based on inputted information, such as a commodity type and an ambient light color bias type. For example, in this disclosure, the image generation model is configured to generate a color compensation image, a poster, or the like.

Commodity element: The commodity element refers to an image element related to a commodity that is generated based on a commodity type, for example, when the commodity type "child short-sleeve shirt" is used as a keyword, various styles of child short-sleeve shirt image elements may be generated for use in producing images such as posters.

Background layer: The background layer is a background part that is used in an image such as a poster and that is generated based on an ambient light color bias type. For example, when the ambient light color bias type is a yellow bias, the compensation color information is determined as blue, and the background layer may be set to blue.

For example, when the commodity type is child short-sleeve shirt within the category of children garment, the commodity type "child short-sleeve shirt" may be directly used as a keyword to generate corresponding apparel materials (i.e., the foregoing commodity elements). The apparel materials may be various styles of child short-sleeve shirt image elements. When the ambient light color bias type is the yellow bias, the ambient light compensation color information may be determined as blue, and the background layer may be set to blue. The child short-sleeve shirt image elements are then superposed onto the blue background layer, and fine tuning and layout of the image elements are performed, to complete generation of the poster.

In some examples, when marketing is to be performed, marketing information may be inputted into the AI model together with the commodity type and the ambient light color bias type. The marketing information is fused with a preset marketing template to obtain a fused marketing template image. The marketing information may include, for example, a marketing title of a commodity, a commodity image, an activity date, a discount amount, and the like. The preset marketing template may be a template image including respective marketing information bars. The fusing process of the marketing information and the preset marketing template may be: filling in the respective marketing information bars with corresponding marketing information, to obtain the fused marketing template image. Then the background color of the fused marketing template image is then adjusted based on the ambient light compensation color information to obtain an adjusted marketing image. Finally, commodity elements corresponding to the commodity type are superposed onto the adjusted marketing image, to complete generation of the poster.

Fused marketing template image: The fused marketing template image is an image obtained by fusing marketing information with a preset marketing template, and is generated by filling each piece of marketing information into a corresponding marketing information bar of the preset marketing template.

Preset marketing template: The preset marketing template is a template image including various marketing information bars, and is configured to be fused with marketing information. For example, marketing information such as a marketing title of a commodity, a commodity image, an activity date, and a discount amount is filled in a corresponding marketing information bar, to obtain a fused marketing template image.

In a scenario example, sales data in a point of sales terminal (POS) machine or a palm verification device may further be obtained, and hot-selling commodities or recommended commodities (for example, discounts or promotions) are displayed in a poster with reference to the sales data. For example, sales data from the past month may be obtained. By analyzing these sales data, information such as sales amount, sales quantity, and sales profit for various commodities can be obtained. Based on the information, hot-selling commodities and commodities with the highest sales profit for the past month can be determined. During the process of generating the poster through AIGC, corresponding image elements of these commodities may be generated and fused into the poster, to display these commodities in the poster. Hot-selling commodity: The hot-selling commodity is a commodity that is determined by analyzing sales data and that is outstanding in indicators such as a sales amount and sales quantity in a time period, and may be displayed in a poster to attract customers.

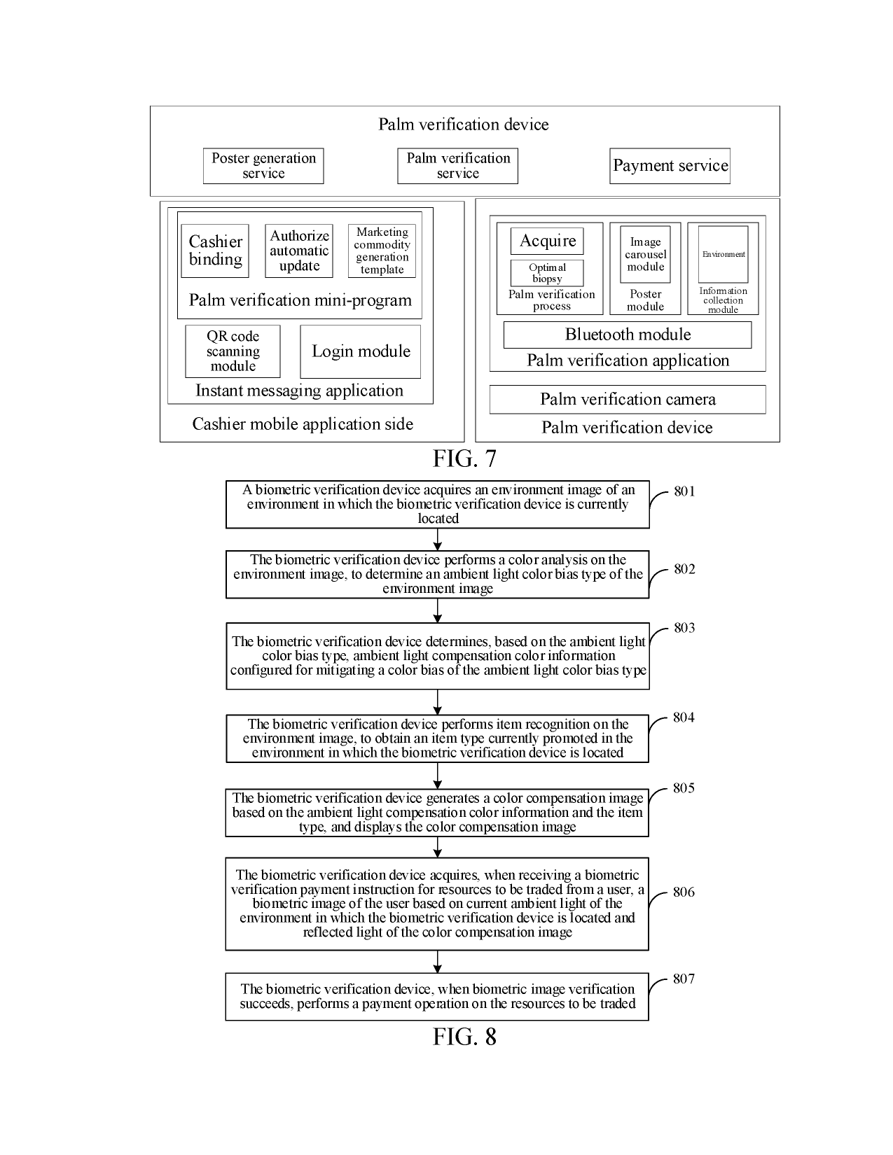

FIG. 7 is a service architecture diagram of this disclosure. In some examples, after a palm verification device is deployed at a merchant store, a cashier can log in to a communication account of the cashier through a login module of an instant messaging application on the cashier mobile application side. The cashier can then scan QR code information on the palm verification device side using a QR code scanning module of the instant messaging application. Through a palm verification mini-program, the palm verification device is bound to the communication account of the cashier, and the cashier can also authorize the palm verification device to automatically update posters. After the palm verification device is configured with an automatic poster update capability, the palm verification device can, through an information collection module and a palm image acquisition camera thereon, acquire ambient light information, to determine ambient light compensation color information corresponding to the ambient light information. The device can also acquire commodity types of the store using the palm image acquisition camera. Based on the ambient light compensation color information and the commodity types, a color compensation image (electronic poster) is generated by using a poster generation service provided by a poster module. When the cashier chooses to perform commodity marketing, a new color compensation image needs to be generated. The palm verification device may obtain marketing information configured by the cashier through the marketing commodity generation template. Based on the marketing information, the ambient light compensation color information, and the commodity types, the new color compensation image is generated by using the poster generation service, to improve the display of the color compensation image in an image carousel module of the poster module on the palm verification device. When a user purchases a commodity and performs payment, the diffuse reflection generated by the color compensation image may neutralize the color bias of the ambient light, enabling acquisition of a palmprint image. The palm verification service provided by the palm verification device then performs an optimal frame selection and identity verification on the palmprint image to determine the identity information of the user, and then the payment is performed through the payment service. In an embodiment, the palm verification device side may alternatively be provided with a Bluetooth module. The Bluetooth module may be configured to implement communication connection with the cashier mobile application side.

Optimal frame selection: The frame selection may refer to a process in which a biometric verification device screens acquired palm streaming data. During this process, a comprehensive evaluation is performed based on factors such as palm size, angle, image contrast, image brightness, and image clarity, so as to select the optimal palm image for subsequent identity verification. Marketing commodity generation template: A marketing commodity generation template may refer to a template opened by a cashier in a palm verification mini-program on a mobile application side, configured to fill in marketing information such as a marketing title of a commodity, a commodity image, an activity date, and a discount amount, so as to regenerate a poster including marketing content.

In this embodiment, the biometric verification device can obtain ambient light information of the environment in which the verification device is currently located, determine the ambient light color bias type based on the ambient light information, and determine, based on the ambient light color bias type, the ambient light compensation color information configured for mitigating the color bias of the ambient light color bias type; generate the color compensation image based on the ambient light compensation color information, and display the color compensation image; acquire, in response to the biometric verification payment instruction, the biometric image under the mixed ambient light that is compensated by the reflected light of the color compensation image in the environment in which the biometric verification device is located; and perform the payment operation when the identity verification based on the biometric image succeeds.

In this disclosure, the ambient light color bias type corresponding to the current ambient light may be determined, to generate the color compensation image configured for adjusting the ambient light color bias type, so that when the user performs payment, the biometric image of the user is acquired with reference to the reflected light of the color compensation image. In this manner, the color bias of the acquired biometric image can be adjusted, quality of the biometric image can be improved, accuracy and efficiency of identity verification of the user are facilitated, and payment efficiency is improved.

According to the method described in the foregoing embodiments, the following further provides descriptions.

Embodiments of this disclosure provide a payment method. As shown in FIG. 8, an example procedure of the payment method is as follows:

801: A biometric verification device acquires an environment image of an environment in which the biometric verification device is currently located.

The biometric verification device may be a user identity recognition device such as a palm verification device or a face verification device. In some examples, the biometric verification device may be placed in an offline merchant store, and the environment in which the biometric verification device is currently located may be the offline merchant store in which the biometric verification device is placed.

The environment image may be an image acquired by using a front-facing camera of the biometric verification device. In some examples, the biometric verification device integrates a display screen and camera hardware, and the camera hardware is located on a same side of the display screen of the biometric verification device.

The acquired environment image may include ambient light information. In some examples, the environment image may be an image in an RGB color mode.

802: The biometric verification device performs a color analysis on the environment image, to determine an ambient light color bias type of the environment image.

In an embodiment, the operation of "performing a color analysis on the environment image, to determine the ambient light color bias type of the environment image" may include: performing color space conversion on the environment image, to obtain a converted image; performing area division on the converted image, to obtain a plurality of image areas; and determining the ambient light color bias type of the environment image based on color bias information of each image area.

Converted image: The converted image refers to an image obtained after color space conversion is performed on an environment image. In some examples, the environment image may be converted from an RGB color space to a color space such as YCbCr or Lab. These color spaces can better represent color features of the image, and separate information such as brightness and chroma.

The performing color space conversion on the environment image may be converting the environment image from the RGB color space to another color space, such as YCbCr or Lab.

In an embodiment, the operation of "determining the ambient light color bias type of the environment image based on color bias information of each image area" may include: calculating, for each image area, area color temperature information of the image area; determining the color bias type of the image area based on the area color temperature information of the image area; and collecting statistics on a color bias type of each image area, to obtain frequency information of occurrence of each preset color bias type; and determining the ambient light color bias type of the environment image based on the frequency information.

The preset color bias type may include a blue bias, a red bias, a green bias, and the like.

In some examples, a higher color temperature indicates a stronger blue bias of the light; and a lower color temperature indicates a strong red bias of the light. The area color temperature information of the image area may reflect a color bias state of the ambient light.

803: The biometric verification device determines, based on the ambient light color bias type, ambient light compensation color information configured for mitigating a color bias of the ambient light color bias type.

In this embodiment, the operation of "determining, based on the ambient light color bias type, ambient light compensation color information configured for mitigating a color bias of the ambient light color bias type" may include: obtaining a color compensation mapping relation set based on the color superposition algorithm, the color compensation mapping relation set including a mapping relation between each preset color bias type and ambient light compensation color information; and determining, based on the color compensation mapping relation set, ambient light compensation color information configured for adjusting the ambient light color bias type.

The color superposition algorithm is based on an additive color principle of an RGB color space, and ambient light compensation color information corresponding to an ambient light color bias type is calculated, so as to neutralize the color bias of the ambient light. The color superposition algorithm is based on the additive color principle of the RGB color space. In an RGB color mode, when three colors, namely, red, green, and blue, are mixed in equal proportions, color components of the three colors balance each other, and a white color is rendered after the mixing. However, not any superposition of colors can produce white, and a superposition effect of different colors depends on the combination of components in the RGB color space.

804: The biometric verification device performs item recognition on the environment image, to obtain an item type currently promoted in the environment in which the biometric verification device is located.

Item recognition may be performed on the environment image by using an AI image recognition technology. In some examples, feature extraction may be performed on the environment image by using an image recognition model, to obtain image feature information, and then the item type in the environment image is predicted based on the image feature information by using a classification algorithm such as a support vector machine (SVM).

805: The biometric verification device generates a color compensation image based on the ambient light compensation color information and the item type, and displays the color compensation image.

In some examples, the environment in which the biometric verification device is located may be an offline merchant store, the environment image may include some commodities sold in the offline merchant store, and an item type currently promoted to be sold in the offline merchant store may be determined by performing item recognition on the environment image, so as to generate the color compensation image based on the ambient light compensation color information and the item type. For example, the ambient light compensation color information may be used as a background color of an image, and then an image element related to the item type is added, to generate the color compensation image. The generated color compensation image may be used as a poster of the offline merchant store, to promote commodities of these item types by using the poster.

In this embodiment, the operation of "generating a color compensation image based on the ambient light compensation color information, and displaying the color compensation image" may include: generating an initial compensation image based on the ambient light compensation color information and the item type; obtaining a marketing requirement selection instruction; and determining, when the marketing requirement selection instruction instructs not to perform marketing, the initial compensation image as a to-be-presented color compensation image, and displaying the color compensation image.

In this embodiment, after the initial compensation image is generated based on the ambient light compensation color information and the item type, a user may be asked whether marketing information should be inputted to further regenerate a poster, and a marketing requirement selection instruction inputted by the user is obtained. If the user chooses not to perform the marketing, the initial compensation image may be directly used as a finally displayed color compensation image. If the user chooses to perform the marketing, image generation is to be performed again.

In this embodiment, the payment method may further include: obtaining marketing information when the marketing requirement selection instruction instructs to perform the marketing; and generating and displaying target promotion content based on the ambient light compensation color information, the item type, and the marketing information.

When the user chooses to perform the marketing, marketing information configured by the user may be obtained. The marketing information may be marketing information for a commodity, and may include a marketing title of a commodity, a commodity image, an activity date, a discount amount, and the like. After the marketing information is obtained, the ambient light compensation color information may be used as the background color of the image, and the marketing information and the item type corresponding to the environment image are fused, to generate the target promotion content.

806: The biometric verification device acquires, when receiving a biometric verification payment instruction for resources to be traded from the user, a biometric image of the user based on current ambient light of an environment in which the biometric verification device is located and reflected light of the color compensation image.

In this embodiment, the reflected light generated by the color compensation image may be used to neutralize the color bias of the ambient light, so that the color bias of the acquired biometric image is reduced, facilitating improving quality of the biometric image.

In some examples, when the biometric verification device is the face verification device, the biometric image may be the face image. When the biometric verification device is the palm verification device, the biometric image may be the palmprint image.

807: The biometric verification device, when biometric image verification succeeds, performs a payment operation on the resources to be traded.

In some examples, a feature of the ambient light can affect accuracy of tasks such as identity detection and identification. In this disclosure, the ambient light color bias type corresponding to the ambient light information can be analyzed, and the color compensation image is generated based on the ambient light color bias type, so that the biometric image is acquired with reference to diffuse reflection of the color compensation image, to obtain better image quality.

In this embodiment, the biometric verification device may acquire the environment image of the current environment in which the biometric verification device is currently located; perform a color analysis on the environment image, to determine the ambient light color bias type of the environment image; determine, based on the ambient light color bias type, the ambient light compensation color information configured for mitigating the color bias of the ambient light color bias type; perform item recognition on the environment image, to obtain the item type currently promoted in the environment in which the biometric verification device is located; generate the color compensation image based on the ambient light compensation color information and the item type, and display the color compensation image; and acquire, in response to the biometric verification payment instruction, the biometric image under the mixed ambient light that is compensated by the reflected light of the color compensation image in the environment in which the biometric verification device is located; and perform, when identity verification based on the biometric image succeeds, a payment operation.

In this disclosure, the ambient light color bias type corresponding to the current ambient light may be determined, to generate the color compensation image for adjusting the ambient light color bias type, so that when the user performs payment, the biometric image of the user is acquired with reference to the reflected light of the color compensation image. In this manner, the color bias of the acquired biometric image can be adjusted, quality of the biometric image can be improved, accuracy and efficiency of identity verification of the user are facilitated, and payment efficiency is improved.

The biometric verification device first obtains the ambient light information of the current environment and determines the ambient light color bias type based on the information. Subsequently, the device determines, based on the ambient light color bias type, the ambient light compensation color information for mitigating the bias, and generates the color compensation image for displaying. When the user triggers the biometric verification payment instruction, the device acquires the biometric image under the mixed ambient light that is compensated by the reflected light of the color compensation image. If the identity verification based on the biometric image succeeds, the payment operation is performed. Acquisition quality of the biometric image is improved by using the ambient light compensation technology, to improve accuracy of identity verification and payment efficiency.

Further, in the payment method based on environment image analysis, the environment image of the current environment is acquired, and the color analysis is performed on the environment image to determine the ambient light color bias type. Based on this, the device generates and displays the color compensation image. When the user initiates the biometric verification payment instruction, the device acquires the biometric image under the mixed ambient light, and performs the payment operation after the verification succeeds. The ambient light information is obtained by directly analyzing the environment image, to improve accuracy of determining the ambient light color bias, and further optimize acquisition effect of the biometric image.

Further, in the payment method integrating item recognition, after the environment image is acquired, not only the ambient light color bias type is analyzed, but also the item type promoted in the current environment is obtained through item recognition. Subsequently, the device generates the color compensation image with reference to the ambient light compensation color information and the item type. During payment of the user, the device acquires the biometric image under the mixed ambient light and completes payment after verification succeeds. By combining item recognition and ambient light compensation, not only payment efficiency is improved, but also commodity promotion can be performed by using the color compensation image, to increase commercial value.

Further, in the payment method based on artificial intelligence image generation, the ambient light compensation color information and the item type are inputted into the artificial intelligence image generation model, to generate the color compensation image. During payment of the user, the device acquires the biometric image under the mixed ambient light, and performs the payment operation after verification succeeds. The color compensation image is generated by using the artificial intelligence technology, to enhance flexibility and adaptability of image generation, and further improve user experience and image acquisition quality in a payment process.

Further, in the color analysis method based on area division, the device performs color space conversion on the acquired environment image and divides the environment image into the plurality of image areas. The color bias information of each area is analyzed, and statistics on a frequency of each color bias type are collected, to determine the ambient light color bias type. Based on this, the device generates and displays the color compensation image, acquires the biometric image under the mixed ambient light during payment of the user, and completes payment after verification succeeds. The ambient light color bias type is determined more precisely by area division and statistics collection on the frequency, to further optimize an acquisition condition of the biometric image.

Further, in the payment method based on area color temperature analysis, color temperature information is calculated for each area of the environment image, the color bias type of each area is determined, and the entire ambient light color bias type is determined by statistics collection on the frequency. Subsequently, the device generates and displays the color compensation image, acquires the biometric image during payment of the user, and performs the payment operation after verification succeeds. The ambient light color bias is accurately determined through color temperature analysis, to further improve the accuracy of acquiring the biometric image and the payment efficiency.

Further, in the payment method based on the color superposition algorithm, the color compensation mapping relation set is obtained by using the color superposition algorithm, compensation color information configured for adjusting the ambient light color bias is determined, and the color compensation image is generated. During payment of the user, the device acquires the biometric image under the mixed ambient light and completes payment after verification succeeds. The compensation color information is accurately generated by using the color superposition algorithm, to effectively improve the acquisition quality of the biometric image and improve payment efficiency.

Further, in the payment method integrating a marketing requirement, after generating the initial compensation image, the device obtains the marketing requirement selection instruction of the user. The device directly displays the initial compensation image if the user chooses not to perform the marketing; or obtains marketing information and generates the target promotion content if the user chooses to perform the marketing. During payment of the user, the device acquires the biometric image under the mixed ambient light, and performs the payment operation after verification succeeds. With reference to the marketing requirement, color compensation image content is flexibly adjusted, to improve payment efficiency and meet commercial promotion requirements.

Further, in the payment method based on promotion image fusion, the device determines the promotion image style information based on the ambient light compensation color information and the item type, and fuses the promotion image style information with the original promotion image to generate the color compensation image. During payment of the user, the device acquires the biometric image under the mixed ambient light and completes payment after verification succeeds. A more targeted color compensation image is generated by using an image fusion technology, to further improve image acquisition quality and payment efficiency.

Further, the payment method applicable to different biometric verification devices supports the palm verification device or the face verification device. The palm image or the face image is acquired based on a device type as the biometric image, and acquisition is completed under the mixed ambient light. During payment of the user, the device performs a payment operation after the verification succeeds. By adapting different biometric verification devices, an application range of the payment method is expanded, and universality and flexibility of a payment system are improved.

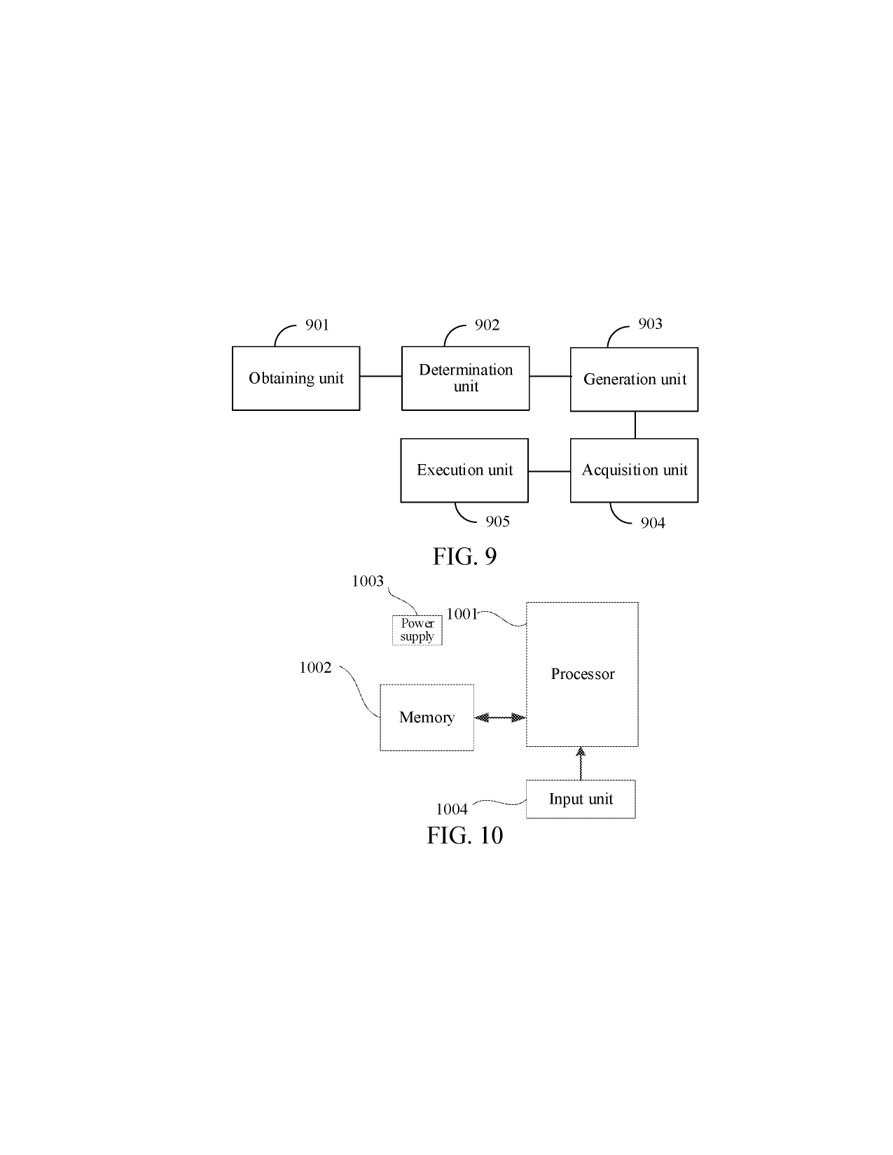

To better implement the foregoing method, embodiments of this disclosure further provide a payment apparatus. As shown in FIG. 9, the payment apparatus may include an obtaining unit 901, a determination unit 902, a generation unit 903, an acquisition unit 904, and an execution unit 905.

(1) Obtaining unit 901:

The obtaining unit 901 is configured to obtain ambient light information of an environment in which a biometric verification device is currently located, and determine an ambient light color bias type of the environment based on the ambient light information.

In some embodiments of this disclosure, the obtaining unit 901 may include an acquisition subunit and a color analysis subunit.

The acquisition subunit is configured to acquire an environment image of the environment in which the biometric verification device is currently located.

The color analysis subunit is configured to perform a color analysis on the environment image, to determine the ambient light color bias type of the environment image.

In some embodiments of this disclosure, the color analysis subunit may be configured to perform color space conversion on the environment image, to obtain a converted image; perform area division on the converted image, to obtain a plurality of image areas; and determine the ambient light color bias type of the environment image based on color bias information of each image area.

In some embodiments of this disclosure, the color analysis subunit may be configured to: calculate, for each image area, area color temperature information of the image area; determine a color bias type of the image area based on the area color temperature information of the image area; and collect statistics on a color bias type of each image area, to obtain frequency information of occurrence of each preset color bias type; and determine the ambient light color bias type of the environment image based on the frequency information.

(2) Determination unit 902:

The determination unit 902 is configured to determine, based on the ambient light color bias type, ambient light compensation color information configured for mitigating a color bias of the ambient light color bias type.

In some embodiments of this disclosure, the determination unit 902 may include a mapping relation obtaining subunit and a color determination subunit.

The mapping relation obtaining subunit is configured to obtain a color compensation mapping relation set based on a color superposition algorithm. The color compensation mapping relation set includes a mapping relation between each preset color bias type and ambient light compensation color information.

The color determination subunit is configured to determine, based on the color compensation mapping relation set, ambient light compensation color information configured for adjusting the ambient light color bias type.

(3) Generation unit 903:

The generation unit 903 is configured to generate a color compensation image based on the ambient light compensation color information, and display the color compensation image.

In some embodiments of this disclosure, the generation unit 903 may include an item recognition subunit and a generation subunit.

The item recognition subunit is configured to perform item recognition on the environment image, to obtain an item type currently promoted in the environment in which the biometric verification device is located.

The generation subunit is configured to generate a color compensation image based on the ambient light compensation color information and the item type, and display the color compensation image.

In some embodiments of this disclosure, the generation subunit may be configured to generate an initial compensation image based on the ambient light compensation color information and the item type; obtain a marketing requirement selection instruction; and determine, when the marketing requirement selection instruction instructs not to perform marketing, that the initial compensation image is a to-be-presented color compensation image, and display the color compensation image.

In some embodiments of this disclosure, the generation unit 903 may further include a marketing information obtaining subunit and a regeneration subunit.

The marketing information obtaining subunit is configured to obtain marketing information when the marketing requirement selection instruction instructs to perform marketing.

The regeneration subunit is configured to generate and display target promotion content based on the ambient light compensation color information, the item type, and the marketing information.

In some embodiments of this disclosure, the generation subunit may be configured to determine, based on the ambient light compensation color information and the item type, promotion image style information for an environment in which the biometric verification device is located; obtain an original promotion image; fuse the promotion image style information with the original promotion image, to obtain a color compensation image; and display the color compensation image.

(4) Acquisition unit 904:

The acquisition unit 904 is configured to acquire, in response to a biometric verification payment instruction, a biometric image under mixed ambient light that is compensated by reflected light of the color compensation image in the environment in which the biometric verification device is located.

(5) Execution unit 905:

The execution unit 905 is configured to perform a payment operation when identity verification based on the biometric image succeeds.

In this embodiment, the obtaining unit 901 may obtain the ambient light information of the environment in which the biometric verification device is currently located, and determine the ambient light color bias type of the environment based on the ambient light information; the determination unit 902 determines, based on the ambient light color bias type, the ambient light compensation color information configured for mitigating the color bias of the ambient light color bias type; and the generation unit 903 generates the color compensation image based on the ambient light compensation color information, and displays the color compensation image; the acquisition unit 904 generates, in response to the biometric verification payment instruction, the biometric image under the mixed ambient light that is compensated by the reflected light of the color compensation image in the environment in which the biometric verification device is located; and the execution unit 905 performs a payment operation when identity verification based on the biometric image succeeds.

In this disclosure, the ambient light color bias type corresponding to the current ambient light may be determined, to generate the color compensation image for adjusting the ambient light color bias type, so that when the user performs payment, the biometric image of the user is acquired with reference to the reflected light of the color compensation image. In this manner, the color bias of the acquired biometric image can be adjusted, quality of the biometric image can be improved, accuracy and efficiency of identity verification of the user are facilitated, and payment efficiency is improved.

Embodiments of this disclosure further provide a biometric verification device. FIG. 10 is a schematic structural diagram of the biometric verification device according to an embodiment of this disclosure. In some examples, the biometric verification device may include components such as a processor 1001 of one or more processing cores, a memory 1002 of one or more computer-readable storage media, a power supply 1003, and an input unit 1004. Those skilled in the art may understand that the structure of the biometric verification device shown in FIG. 10 does not constitute a limit to the biometric verification device. The device may include more or fewer parts than those shown in the figure, may combine some parts, or may have different part arrangements.

In some examples, the processor 1001 is a control center of the biometric verification device, is connected to all parts of the entire biometric verification device by using various interfaces and lines, and executes various functions of the biometric verification device and performs data processing by running or executing a software program and/or a module stored in the memory 1002 and calling data stored in the memory 1002. In some embodiments, the processor 1001 may include one or more processing cores. In some examples, the processor 1001 may integrate an application processor and a modem processor, where the application processor handles an operating system, a user interface, application programs, etc., and the modem processor handles wireless communication. The modem processor may not be integrated into the processor 1001.

In some examples, the memory 1002stores the software program and the module, and the processor 1001 executes various function applications and performs data processing by running the software program and the module stored in the memory 1002. The memory 1002 can include a program storage area and a data storage area. The program storage area may store an operating system, an application program used by at least one function (such as a sound playing function and an image display function), and the like. The data storage area may store data created based on use of the biometric verification device, and the like. In addition, the memory 1002 may include a high speed random access memory, and may alternatively include a non-volatile memory, such as at least one magnetic disk storage device, a flash memory, or another volatile solid-state storage device. Correspondingly, the memory 1002 may further include a memory controller to provide access of the processor 1001 to the memory 1002.

The biometric verification device further includes the power supply 1003 for supplying power to the components. In some examples, the power supply 1003 may be logically connected to the processor 1001 by using a power management system, thereby implementing functions such as charging, discharging, and power consumption management by using the power management system. The power supply 1003 may further include one or more of a direct current or alternating current power supply, a re-charging system, a power failure detection circuit, a power supply converter or inverter, a power supply state indicator, and any other components.

The biometric verification device may further include the input unit 1004. The input unit 1004 may be configured to receive entered numeric or character information and generate keyboard, mouse, joystick, optical, or trackball signal input related to a user setting and function control.

Although not shown in the figure, the biometric verification device may further include a display unit, and the like. Details are not described herein again. In some examples, in this embodiment, the processor 1001 of the biometric verification device loads executable files corresponding to processes of one or more applications to the memory 1002 based on the following instructions, and the processor 1001 runs the applications stored in the memory 1002, to achieve various functions. The instructions include: obtaining ambient light information of an environment in which the biometric verification device is currently located, and determining an ambient light color bias type of the environment based on the ambient light information; determining, based on the ambient light color bias type, ambient light compensation color information configured for mitigating a color bias of the ambient light color bias type; generating a color compensation image based on the ambient light compensation color information, and displaying the color compensation image; acquiring, in response to a biometric verification payment instruction, a biometric image under mixed ambient light that is compensated by reflected light of the color compensation image in the environment in which the biometric verification device is located; and performing a payment operation when identity verification based on the biometric image succeeds.

For implementation examples of the above operations, refer to the foregoing embodiments. Details are not described herein again.

In this embodiment, the ambient light information of the environment in which the biometric verification device is currently located can be obtained, and the ambient light color bias type of the environment can be determined based on the ambient light information; the ambient light compensation color information configured for mitigating the color bias of the ambient light color bias type can be determined based on the ambient light color bias type; the color compensation image is generated based on the ambient light compensation color information, and is displayed; in response to the biometric verification payment instruction, the biometric image is generated under the mixed ambient light that is compensated by the reflected light of the color compensation image in the environment in which the biometric verification device is located; and when the identity verification based on the biometric image succeeds, the payment operation is performed.

In this disclosure, the ambient light color bias type corresponding to the current ambient light may be determined, to generate the color compensation image for adjusting the ambient light color bias type, so that when the user performs payment, the biometric image of the user is acquired with reference to the reflected light of the color compensation image. In this manner, the color bias of the acquired biometric image can be adjusted, quality of the biometric image can be improved, accuracy and efficiency of identity verification of the user are facilitated, and payment efficiency is improved.

All or some operations of the methods in the foregoing embodiments may be implemented by using instructions, or implemented through instructions controlling relevant hardware, and the instructions may be stored in a computer-readable memory and loaded and executed by a processor.

Accordingly, embodiments of this disclosure provide a computer-readable storage medium having a plurality of instructions stored therein. The instructions can be loaded by the processor, to perform the operations in any payment method according to the embodiments of this disclosure. For example, the instructions may perform the following operations: obtaining ambient light information of an environment in which the biometric verification device is currently located, and determining an ambient light color bias type of the environment based on the ambient light information; determining, based on the ambient light color bias type, ambient light compensation color information configured for mitigating a color bias of the ambient light color bias type; generating a color compensation image based on the ambient light compensation color information, and displaying the color compensation image; acquiring, in response to a biometric verification payment instruction, a biometric image under mixed ambient light that is compensated by reflected light of the color compensation image in the environment in which the biometric verification device is located; and performing a payment operation when identity verification based on the biometric image succeeds.

For implementation examples of the above operations, refer to the foregoing embodiments. Details are not described herein again.

The computer-readable storage medium may include: a read-only memory (ROM), a random access memory (RAM), a magnetic disk, an optical disc or the like.

Since the instructions stored in the computer-readable storage medium may perform the operations of any payment method provided in the embodiments of this disclosure, the computer-readable storage medium can implement beneficial effects that may be implemented by any image processing method according to the embodiments of this disclosure. The foregoing embodiments may be referred to for details. Details are not further described herein.

According to an aspect of this disclosure, a computer program product or a computer program is provided, where the computer program product or the computer program includes computer instructions, and the computer instructions are stored in the computer-readable storage medium. A processor of a computer device reads the computer instructions from the computer-readable storage medium, and the processor executes the computer instructions, so that the computer device is enabled to perform the method provided in various implementations of the foregoing payment aspect.

The payment methods and apparatuses, the devices, the media, and the program products provided in the embodiments of this disclosure are described in further detail above. The principles and the implementations of this disclosure are described in this specification by using examples. The foregoing descriptions about the embodiment are merely provided to help understand the method and the core idea of this disclosure. In addition, changes can be made to the implementation examples and the application scope according to the idea of this disclosure. Therefore, the content of this specification is not to be understood as a limitation on this disclosure.

One or more modules, submodules, and/or units of the apparatus can be implemented by processing circuitry, software, or a combination thereof, for example. The term module (and other similar terms such as unit, submodule, etc.) in this disclosure may refer to a software module, a hardware module, or a combination thereof. A software module (e.g., computer program) may be developed using a computer programming language and stored in memory or non-transitory computer-readable medium. The software module stored in the memory or medium is executable by a processor to thereby cause the processor to perform the operations of the module. A hardware module may be implemented using processing circuitry, including at least one processor and/or memory. Each hardware module can be implemented using one or more processors (or processors and memory). Likewise, a processor (or processors and memory) can be used to implement one or more hardware modules. Moreover, each module can be part of an overall module that includes the functionalities of the module. Modules can be combined, integrated, separated, and/or duplicated to support various applications. Also, a function being performed at a particular module can be performed at one or more other modules and/or by one or more other devices instead of or in addition to the function performed at the particular module. Further, modules can be implemented across multiple devices and/or other components local or remote to one another. Additionally, modules can be moved from one device and added to another device, and/or can be included in both devices.

The use of “at least one of” or “one of” in the disclosure is intended to include any one or a combination of the recited elements. For example, references to at least one of A, B, or C; at least one of A, B, and C; at least one of A, B, and/or C; and at least one of A to C are intended to include only A, only B, only C or any combination thereof. References to one of A or B and one of A and B are intended to include A or B or (A and B). The use of “one of” does not preclude any combination of the recited elements when applicable, such as when the elements are not mutually exclusive.

The foregoing disclosure includes some embodiments of this disclosure which are not intended to limit the scope of this disclosure. Other embodiments shall also fall within the scope of this disclosure.

What is claimed is:

1. A method for payment, the method comprising:
obtaining ambient light information of ambient light in an environment of a biometric verification device;
determining an ambient light color bias type of the ambient light based on the ambient light information;
determining, based on the ambient light color bias type, ambient light compensation color information for reducing a color bias of the ambient light with the ambient light color bias type;
generating a color compensation image based on the ambient light compensation color information;
displaying the color compensation image by the biometric verification device;
acquiring, when a biometric verification payment instruction is received, a biometric image under mixed ambient light, the mixed ambient light including the ambient light and reflected light of the color compensation image that is displayed by the biometric verification device and the mixed ambient light being compensated to have a reduced color bias than the ambient light; and
performing a payment operation when an identity verification based on the biometric image succeeds.

2. The method according to claim 1, wherein:
the obtaining the ambient light information comprises:
acquiring an environment image in the ambient light of the environment; and
the determining the ambient light color bias type comprises:
performing a color analysis on the environment image, to determine the ambient light color bias type of the environment image.

3. The method according to claim 2, wherein the generating the color compensation image comprises:
performing an item recognition on the environment image, to obtain an item type of an item that is promoted; and
generating the color compensation image based on the ambient light compensation color information and the item type.

4. The method according to claim 3, wherein the generating the color compensation image based on the ambient light compensation color information and the item type comprises:
inputting the ambient light compensation color information and the item type into an artificial intelligence image generation model; and
generating, based on the ambient light compensation color information and the item type, the color compensation image by using the artificial intelligence image generation model.

5. The method according to claim 2, wherein the performing the color analysis on the environment image comprises:
performing a color space conversion on the environment image, to obtain a converted image;
dividing the converted image into a plurality of image areas; and
determining the ambient light color bias type of the environment image based on respective color bias information of the plurality of image areas.

6. The method according to claim 5, wherein the determining the ambient light color bias type comprises:
calculating respective area color temperature information of the plurality of image areas;
determining respective color bias types of the plurality of image areas based on the respective area color temperature information;
collecting statistics on the respective color bias types of the plurality of image areas, to obtain frequency information of occurrences of preset color bias types; and
determining the ambient light color bias type of the environment image based on the frequency information.

7. The method according to claim 1, wherein the determining the ambient light compensation color information comprises:
obtaining a color compensation mapping relation set, the color compensation mapping relation set mapping one or more preset color bias types to respective candidate ambient light compensation color information; and
determining, based on the color compensation mapping relation set, the ambient light compensation color information that maps to the ambient light color bias type.

8. The method according to claim 3, wherein the generating the color compensation image comprises:
generating an initial compensation image based on the ambient light compensation color information and the item type;
obtaining a marketing requirement selection instruction; and
determining, when the marketing requirement selection instruction indicates no marketing, that the initial compensation image is the color compensation image to display.

9. The method according to claim 8, wherein the method further comprises:
obtaining marketing information when the marketing requirement selection instruction instructs to perform marketing; and
generating the color compensation image with target promotion content based on the ambient light compensation color information, the item type, and the marketing information.

10. The method according to claim 3 wherein the generating the color compensation image comprises:
determining, based on the ambient light compensation color information and the item type, promotion image style information;
obtaining an original promotion image; and
fusing the promotion image style information with the original promotion image, to obtain the color compensation image.

11. The method according to claim 1, wherein the acquiring the biometric image comprises at least one of:
acquiring a palm image to be the biometric image when the biometric verification device is a palm verification device; or
acquiring a face image to be the biometric image when the biometric verification device is a face verification device.

12. A biometric verification device, comprising processing circuitry configured to:
obtain ambient light information of ambient light in an environment of the biometric verification device;
determine an ambient light color bias type of the ambient light based on the ambient light information;
determine, based on the ambient light color bias type, ambient light compensation color information for reducing a color bias of the ambient light with the ambient light color bias type;
generate a color compensation image based on the ambient light compensation color information;
display the color compensation image by the biometric verification device;
acquire, when a biometric verification payment instruction is received, a biometric image under mixed ambient light, the mixed ambient light including the ambient light and reflected light of the color compensation image that is displayed by the biometric verification device, and the mixed ambient light being compensated to have a reduced color bias than the ambient light; and
perform a payment operation when an identity verification based on the biometric image succeeds.

13. The biometric verification device according to claim 12, wherein the processing circuitry is configured to:
acquire an environment image in the ambient light of the environment; and
perform a color analysis on the environment image to determine the ambient light color bias type of the environment image.

14. The biometric verification device according to claim 13, wherein the processing circuitry is configured to:
perform an item recognition on the environment image, to obtain an item type of an item that is promoted; and
generate the color compensation image based on the ambient light compensation color information and the item type.

15. The biometric verification device according to claim 14, wherein the processing circuitry is configured to:
input the ambient light compensation color information and the item type into an artificial intelligence image generation model; and
generate, based on the ambient light compensation color information and the item type, the color compensation image by using the artificial intelligence image generation model.

16. The biometric verification device according to claim 13, wherein the processing circuitry is configured to:
perform a color space conversion on the environment image, to obtain a converted image;
divide the converted image into a plurality of image areas; and
determine the ambient light color bias type of the environment image based on respective color bias information of the plurality of image areas.

17. The biometric verification device according to claim 16, wherein the processing circuitry is configured to:
calculate respective area color temperature information of the plurality of image areas;
determine respective color bias types of the plurality of image areas based on the respective area color temperature information;
collect statistics on the respective color bias types of the plurality of image areas, to obtain frequency information of occurrences of preset color bias types; and
determine the ambient light color bias type of the environment image based on the frequency information.

18. The biometric verification device according to claim 12, wherein the processing circuitry is configured to:
obtain a color compensation mapping relation set, the color compensation mapping relation set mapping one or more preset color bias types to respective candidate ambient light compensation color information; and
determine, based on the color compensation mapping relation set, the ambient light compensation color information that maps to the ambient light color bias type.

19. The biometric verification device according to claim 14, wherein the processing circuitry is configured to:
generate an initial compensation image based on the ambient light compensation color information and the item type;
obtain a marketing requirement selection instruction; and
determine, when the marketing requirement selection instruction indicates no marketing, that the initial compensation image is the color compensation image to display.

20. A non-transitory computer-readable storage medium storing instructions which when executed by at least one processor cause the at least one processor to perform:
obtaining ambient light information of ambient light in an environment of a biometric verification device;
determining an ambient light color bias type of the ambient light based on the ambient light information;
determining, based on the ambient light color bias type, ambient light compensation color information for reducing a color bias of the ambient light with the ambient light color bias type;
generating a color compensation image based on the ambient light compensation color information;
displaying the color compensation image by the biometric verification device;
acquiring, when a biometric verification payment instruction is received, a biometric image under mixed ambient light, the mixed ambient light including the ambient light and reflected light of the color compensation image that is displayed by the biometric verification device, and the mixed ambient light being compensated to have a reduced color bias than the ambient light; and
performing a payment operation when an identity verification based on the biometric image succeeds.
